(19) United States
(12) Patent Application Publication
(10) Pub. No.: US 2013/0105619 A1
(43) Pub. Date: May 2, 2013

(54) CAMERA STABILIZATION MECHANISM

(71) Applicants: Michael Sean Buscher, Conroe, TX (US); Henry E. Kulesza, The Woodlands, TX (US)

(72) Inventors: Michael Sean Buscher, Conroe, TX (US); Henry E. Kulesza, The Woodlands, TX (US)

(73) Assignee: VANGUARD DEFENSE INTERNATIONAL, LLC, Spring, TX (US)

(21) Appl. No.: 13/286,893

(22) Filed: Nov. 1, 2011

(51) Int. Cl. B64C 27/00; G03B 17/00; G03B 39/00

(52) U.S. Cl. 244/17.11; 396/13; 396/428; 396/12

(57) ABSTRACT

Camera mount systems are disclosed herein. In one embodiment, a camera mount system is provided, including a first and a second axial arm configured to mount a camera system. The camera mount system further includes a plurality of pistons configured to attach the first and the second axial arms to a vehicle frame. The camera mount system also includes a plurality of springs configured to attach the first and the second axial arms to the vehicle frame, wherein the first and the second axial arms are disposed underslung to the vehicle frame, and wherein the pistons enable a first movement of the first and the second axial arms about a geometric plane and the springs enable a second movement of the first and the second axial arms along an axis normal to the geometric plane.

### BACKGROUND

The present disclosure relates generally to stabilization systems and, more particularly, to camera stabilization systems.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

A variety of situations exist in which a moving camera system may be desired. For example, an aerially-conveyed camera system may be used to assist law enforcement, to spot forest fires, to report vehicular traffic, and more generally, to provide for aerial images and video. Certain camera systems may be conveyed by fixed wing (e.g., airplane) or rotary wing aircraft (e.g., helicopter). For example, a fixed wing or rotary wing unmanned aircraft system (UAS) may be used as an aerial camera platform. The UAS may be directed to a locality of interest and used to provide images and video observations from the locality. In this manner, suitable visual observations may be obtained, without the need to place a human in harm's way.

One difficulty that arises with aerially-conveyed camera systems is the presence of vibration and other unwanted movements in the conveying aircraft. Such vibrations may be transmitted to the camera, resulting in jitter and shaking, thus degrading the quality of the resulting imagery. Indeed, in some circumstances, the degradation may be so great that certain camera systems may be unusable when conveyed by the aircraft. In particular, camera systems capable of higher resolution imagery may be very susceptible to vibration, resulting in unusable images.

There is a need, therefore, for an improved camera stabilization mechanism, and particularly, for an improved camera stabilization mechanism disposed in aircraft. It would be desirable to provide a camera stabilization mechanism that allows the aerial conveyance of camera systems while minimizing the transmission of vibration and of other unwanted movements.

### BRIEF DESCRIPTION

This disclosure provides a novel camera mount suitable for mounting a variety of camera systems, including high resolution camera systems, in aircraft. In certain embodiments, the camera mount may be attached to an airframe, such as the frame of an unmanned aircraft system (UAS). The UAS airframe may be provided as a rotary wing aircraft or a fixed wing aircraft, and may be capable of engaging a target. Additionally, the UAS airframe may be provided in a compact size, such as a size suitable for transporting the UAS in a sports utility vehicle (SUV) and/or mid-size pickup truck. Indeed, the UAS may be sized to be easily transported to a desired locality without resorting to a special transport vehicle. Accordingly, the camera mount may include features useful in minimizing weight while enabling the isolation of the camera system from vibrations, torque, and other unwanted movements of the UAS airframe.

In one example, the camera mount may include two axial arms and a plurality of pistons connecting the axial arms to the UAS airframe. The pistons may be disposed along the same geometric plane as the axial arms, and enable movement of the axial arm in the geometric plane. The pistons may be tuned to certain predominant frequencies, such as the natural frequency of a rotary mast or shaft of a rotary wing UAS. By tuning the pistons to the natural frequency of the main rotary component of the rotary wing UAS, the pistons may absorb vibrations that would have been otherwise transmitted through the airframe and into the camera system. Additionally, the plurality of pistons may be tuned to the predominant frequencies found in fixed wing aircraft.

In one embodiment, the camera mount may include a plurality of flexible rod springs positioned along an axis normal to the geometric plane used to dispose the pistons. The springs may include cables (e.g., wire rope cable, solid cable, cored cable), solid or hollow flexible tubing (e.g., flexible plastic tubing or rods), or other flexible, rod-like material. Accordingly, the pistons may contract and expand along the axis of placement, thus providing for additional dampening of vibrations. The springs may also be tuned to absorb the predominant frequencies of the main rotary component of the UAS. By combining the tuned pistons with the tuned springs in a lightweight frame, the camera mount may enable the acquisition of high quality imagery while minimizing aircraft weight and enhancing the useful life of the camera system. Additionally, the camera mount may be used to maneuver the UAS with improved control, and to acquire and engage targets with enhanced precision.

### BRIEF DESCRIPTION OF THE DRAWINGS

Advantages of the disclosed techniques may become apparent upon reading the following detailed description and upon reference to the drawings in which:

FIG. 1 is a perspective view of an embodiment of a UAS including a camera system;

FIG. 2 is a perspective view of an embodiment of an airframe for the UAS of FIG. 1 and a camera mount installed on the airframe;

FIG. 3 is a top view of the camera mount and the airframe of FIG. 2;

FIG. 4 is a is a frontal view of embodiments of a plurality of springs attached to the camera mount and the airframe of FIG. 3; and

FIG. 5 is a detailed perspective view of one of the springs depicted in FIG. 4 taken through arc 5.

### DETAILED DESCRIPTION OF SPECIFIC EMBODIMENTS

One or more specific embodiments of the present techniques will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

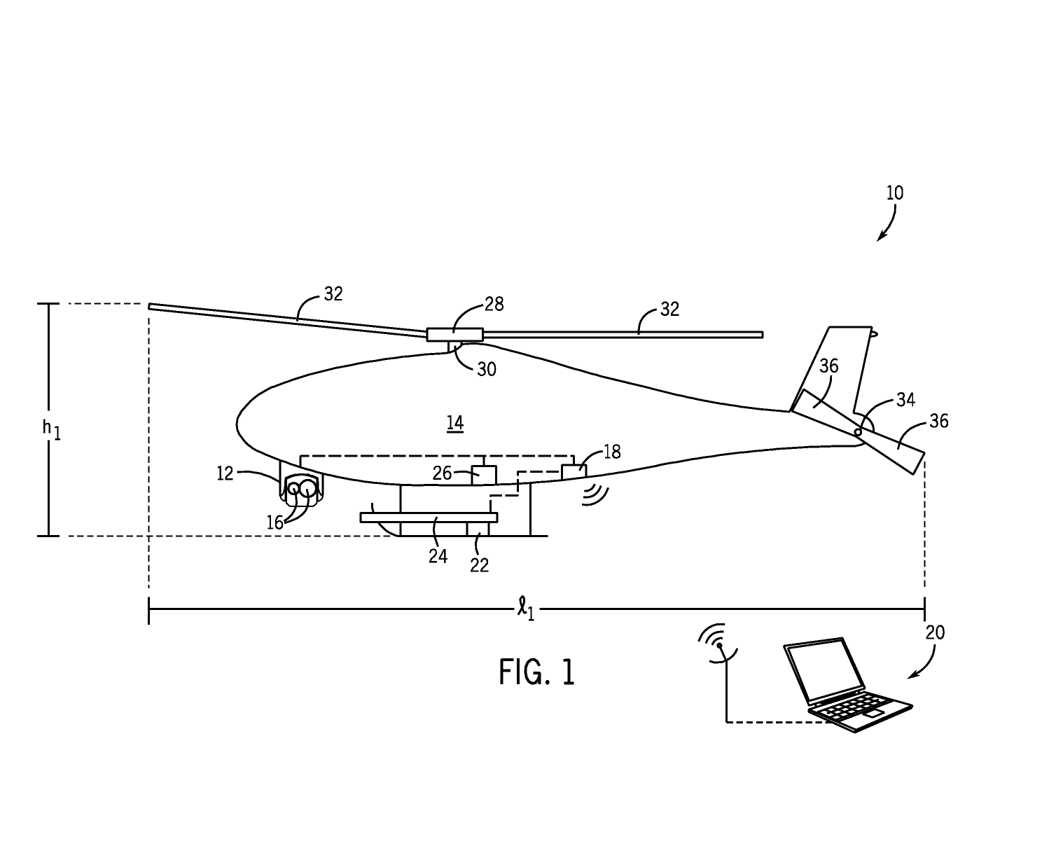

FIG. 1 is illustrative of a UAS 10. While the UAS 10 represented in the figure is a helicopter system, aspects of this disclosure could be applied to other UAS 10, including fixed wing aircraft systems, quadricopters systems, tricopters systems, and the like. The application to a helicopter system is apt, however, insomuch as such helicopter system may be suitable for hovering flight, yet retain similar operational capabilities, e.g., speed, flight time, and flight performance, comparable to other aircraft systems.

In the depicted embodiment, a gimbal system 12 is mounted under a cowling or fuselage 14. The gimbal system 12 may be used in enclosing and operating a camera system 16, while the UAS 10 is in flight. For example, a remote operating system 18 may be used to pan, tilt, rotate, or otherwise position the camera system 16 to obtain imagery at a desired geographic location. Additionally, the remote operating system 18 and the camera system 16 may be used to remotely pilot the UAS 10, thus enabling the remote operator to be situated in a remote location different than the desired geographic location. The camera system 16 may include a variety of cameras, including cameras capable of high resolution imagery (e.g., 1080p video cameras), thermal imagery, forward looking infrared cameras (FLIR), laser radar (LADAR), synthetic aperture radar (SAR), and/or other imaging equipment. During flight, a UAS operator of the remote operating system 18 may receive imagery produced by the camera system 16, and use the imagery to remotely control the UAS 10.

In the illustrated embodiment, a flight station 20 suitable for transmitting and receiving signals (e.g., radio signals) may be communicatively coupled to the gimbal system 12 and to the camera system 16. Signals remotely transmitted from the remote operating system 18 may be received by the flight station 20 and used to control the camera system 16, as well as to operate the flight controls of the UAS 10. Signals transmitted from the remote operating system 18 may include imagery taken through the camera system 16 as well as operational data for the UAS 10 (e.g., speed, altitude, heading, engine data, fuel level, targeting data). Accordingly, the UAS operator may remotely fly the UAS 10, and operate the camera system 16 to capture desired imagery. Additionally, the UAS 10 may include a weapons mount 22 suitable for attaching a weapon, such as a kinetic weapon 24. The kinetic weapon 24 may deliver a kinetic payload (e.g., projectile), and may include a non-lethal weapon, such as an electroshock weapon (e.g., Taser), and/or a lethal weapon, such as a shotgun, rifled gun, or cannon. In other embodiments, a non-kinetic weapon, such as sonic weapon, high powered laser, and so on, may be used. It is to be noted that while the depicted embodiment shows one weapon 24 mounted onto the UAS 10 through the weapons mount 22, other embodiments may include multiple weapons 24.

As illustrated, the weapons mount 22 and weapon 24 may be communicatively coupled to the remote operating system 18. The UAS operator may aim the weapon 24 through the camera system 16 and engage a target. In the presently contemplated embodiment, the weapons mount 22 may be a fixed mount, and the weapon 24 may be pre-sighted for windage and elevation at a given range or ranges (e.g., 50 yards, 100 yards, and 200 yards). In this embodiment, the UAS operator may aim the weapon 24 by positioning the UAS 10 into a desirable targeting position. In other embodiments, the weapons mount 22 may be controllable through the remote operating system 18, and UAS operator may aim or move the weapon 24 independent of the movement of the UAS 10.

The UAS 10 may also include an autopilot and navigation system 26. For example, the autopilot and navigation system 26 may provide for supported and/or autonomous modes of flight control of the UAS 10. In the supported mode of operations, the autopilot and navigation system 26 may aid the UAS operator in flying the UAS 10. For example, while the UAS operator may generally direct the flight of the UAS 10, the autopilot and navigation system 26 may continuously monitor flight parameters (e.g., altitude, speed, gyroscopic parameters) and provide responsive adjustments to counteract effects due to, for example, wind shear, wind gusts, weapon 24 recoil, ground effects, and the like. In an autonomous mode of operation, the UAS operator may direct the UAS 10 to a certain geographic location, for example, by using geographic coordinates. The UAS 10 may then fly to the desired location under autonomous control. Accordingly, the autopilot and navigation system 26 may include a global positioning system (GPS), such as a differential global positioning system (DGPS) suitable for improved, sub-meter positional accuracy. Additionally or alternatively, the autopilot and navigation system 26 may be communicatively coupled to the camera system 16 (e.g., radar, video camera) for terrain avoidance and enhanced navigation.

In the depicted embodiment, the UAS 10 may include a size suitable for transport in a sports utility vehicle, a mid-size pickup truck, or comparably-sized vehicle. For example, the UAS 10 may include an overall length l₁ of less than 15 ft., a width w₁ of less than 3 ft., and height h₁ of less than 4 ft. Such compact dimensions enable the UAS 10 to be easily transported and deployed without the need for a custom transport vehicle. Indeed, the compact UAS 10 may be quickly positioned to observe locations of interest from an above-ground vantage point, thus providing for quick response during intelligence, surveillance, and reconnaissance (ISR) operations. However, the compact dimensions of the UAS 10 may amplify certain vibrations, including vibrations produced by a main rotor 28 having a main rotary mast or shaft 30.

The shaft 30 is rotatably coupled to a main rotor blade 32 and provides a torquing force suitable for rotating the main rotor blade 32 during flight. Indeed, the blade 32 may be rotating at 500 revolutions per minute (RPM) or higher, thus creating lift and thrust. It is to be understood that, in other embodiments, the UAS 10 may include multiple blades 32. For example, 2, 3, 4 or more blades 32 may be used. A tail rotor 34 may also be used, including a tail rotor blade 36 which can counteract the torque created by the main rotor blade 32, thus useful in preventing the UAS 10 from spinning about the blade's 32 axis.

Because of the aerodynamics of rotary wing flight, it may be desirable to keep the main rotor blade 32 within a narrow RPM range. For example, a range of approximately between 90% to 105% of a baseline RPM may be desirable for flight operations. Too low of an in-flight RPM may result in rapid descent with power, while too high of an in-flight RPM may strain certain components of the UAS 10 (e.g., rotors 28, 34). Maintaining the in-flight RPM to a narrower range, such as between 90% to 105% of the baseline RPM, may result in the predominance of a vibration having a natural frequency produced by the rotation of the main rotor 28 and/or the tail rotor 34. This vibration may be transmitted through the airframe and into the camera system 16, resulting in unwanted jitter, blurs, and other motion-related artifacts. Because of the degraded image quality, control of the UAS 10 by the UAS operator using the station 20 may be affected. Likewise, target acquisition capabilities may be degraded, and terrain avoidance may be reduced. Accordingly, it may be useful to dampen the vibration caused by the predominant natural frequency.

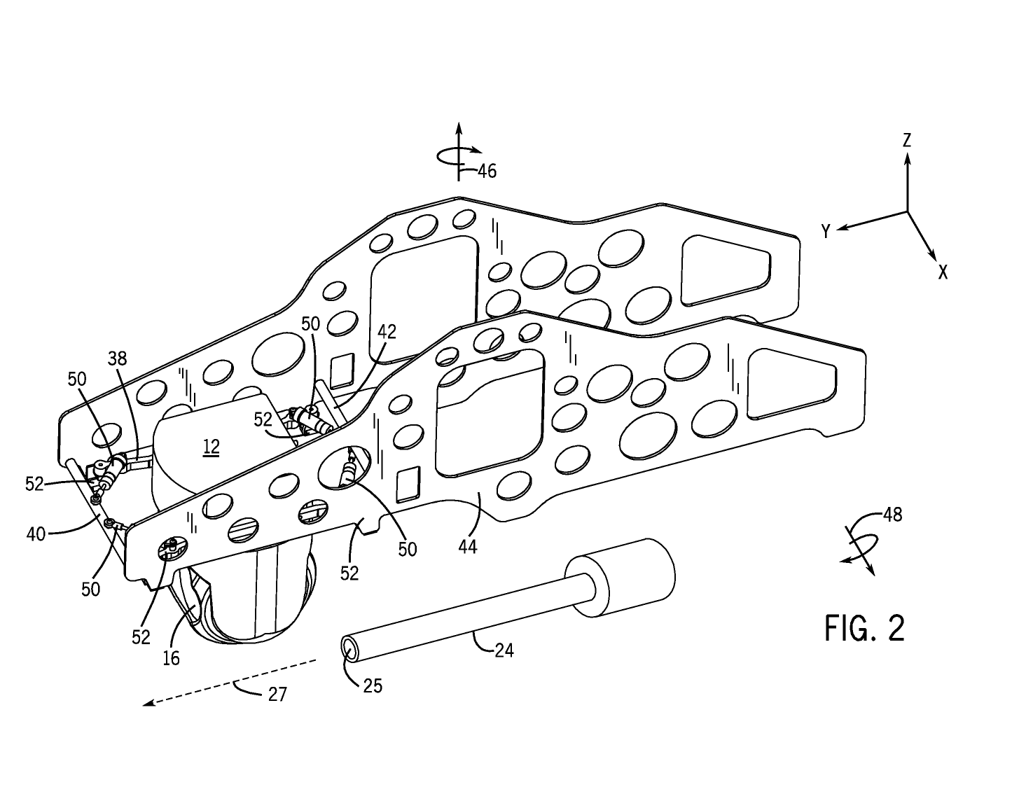

Certain systems disclosed herein, such as a camera mount 38 shown in FIG. 2, may dampen vibrations and motions, including the predominant vibration resulting from one or more of the natural frequencies driven by the main rotor 28 and/or tail rotor 34. By disposing the gimbal system 12 on the camera mount 38, a substantially stable imaging platform may be achieved, capable of obtaining high resolution imagery with little or no jitter or blurs. Accordingly, the UAS operator may be capable of improved control of the UAS 10 through the improved image feedback. For example, the UAS 10 may be manually kept within ±0.5 in., ±1 in., ±5 in., of a desired hovering position. Likewise, improvement in accuracy of the weapon 24 may be achieved. For example, the UAS 10 may provide for an airborne weapon platform suitable for delivering projectiles with minute of angle (MOA) accuracy or better, such as equal to or less than 1 in. at 100 yards, equal to or less than 2 inches at 200 yards, equal to or less than 3 inches at 300 yards, and so forth. Additionally, improved navigation may be enabled. For example, flight obstacles may be detected and avoided at speeds in excess of 50 mph, 75 mph, 100 mph, 150 mph. Indeed, vibration measurements at the gimbal system 12 and camera system 16 may be reduced from over 0.03 inches per second (in./sec.) to less than 0.025 in./sec., which may result in a vibration isolation efficiency (e.g., effectiveness of the camera mount 38 in reducing the transmitted vibration) of over 80%.

In the embodiment depicted in FIG. 2, the camera mount 38 is shown mounted onto a frontal bar 40 and a rear bar 42 included in an airframe 44 of the UAS 10 (shown in FIG. 1). The camera mount 38 is positioned underslung or beneath the airframe 44. Accordingly, the gimbal system 12 containing the camera system 16 may then be positioned under the airframe 44. The underslung positioning of the camera system 16 provides for an improved field of vision, including the ability to capture images directly beneath the UAS 10. The figure also illustrates the weapon 24, which may be generally positioned to with a barrel opening 25 directed to fire a projectile outwardly along an axis 27 (e.g., y-axis).

During flight, the main rotor blade 32 typically rotates about an axis 46 (e.g., z-axis). Likewise, the tail rotor blade 36 typically rotates about an axis 48 (e.g., x-axis). The rotations may induce a vibration, which may be subsequently transmitted through the airframe 44 and into the camera system 16. The vibration may include a predominant frequency w (e.g., natural frequency) caused by the vibratory airloads acting on the main rotor blade 32 and/or the tail rotor blade 36. Other sources of vibration may include an engine, transmission, and aerodynamic forces on the fuselage 14 (shown in FIG. 1). In some cases, the vibrations may result in a movement of 0.03 in./sec. or more affecting the gimbal system 12 and camera system 16, thus degrading image capture, UAS 10 control, and targeting accuracy.

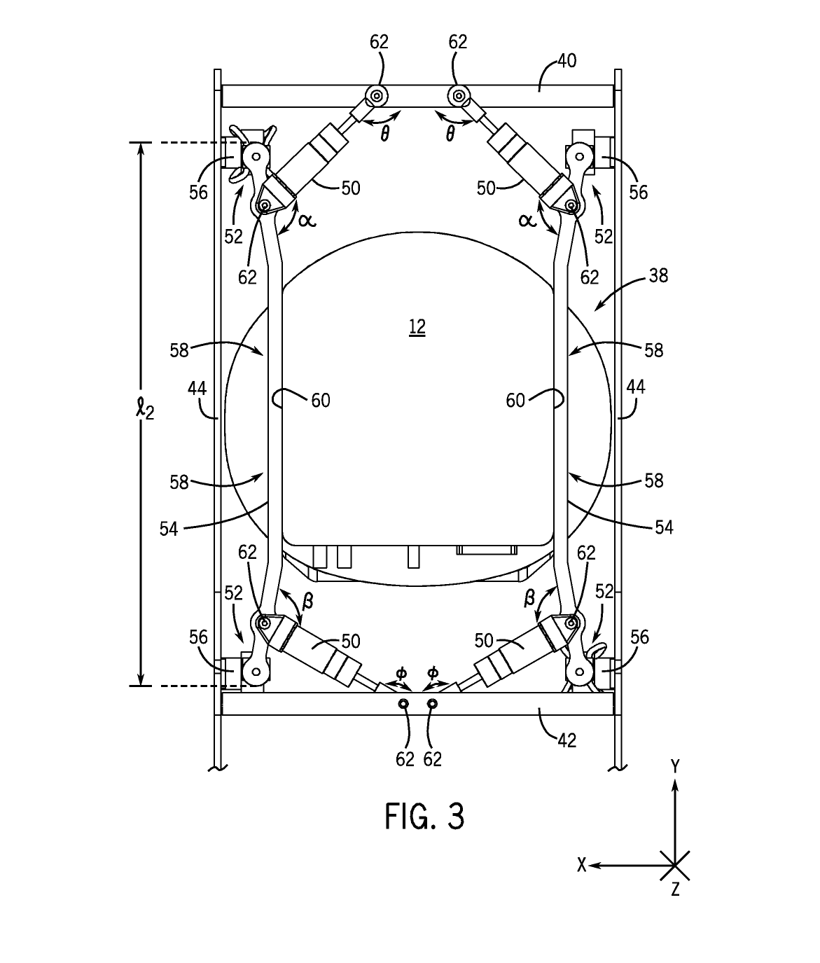

It would be beneficial to identify the predominant frequency or frequencies, and to dampen the related vibrations by using certain features of the camera mount 38, such as pistons 50 and springs 52 described in more detail below with respect to FIG. 3. In one example, an empirical study may be undertaken to determine the predominant frequency or frequencies of the UAS 10. In this example, a vibration analysis system, such as the Vibrex 2000 Plus (V2k+), available from Honeywell, of Morristown, N.J. may be used. The vibration analysis system may monitor sensors, such as load cells, accelerometers, and vibratory sensors, to derive a predominant frequency w and related harmonics.

In another example, a theoretical analysis may be used to derive the predominant vibratory frequency w and related harmonics. In this example, a rotor passage rate P may be used to determine the frequency w and related P harmonics. The rotor passage rate P is defined as the number of times that a blade (e.g., blades rotates relative to a stationary point. The equation (1) below may derive the frequency w through the use of P:

$$w = \frac{baseline\_RPM \times n \times P}{60} \qquad ( 1 )$$

n is the number of rotor blades. For example, given a baseline_RPM of 500, the single-bladed UAS 10 will have a predominant frequency iv at 1P of 8.33 Hz. Other P-based harmonics, based on the rate 1P may also be derived, such as 2P (i.e., 2×w) of 16.67 Hz, 3P of 25 Hz, 4P of 33.33 Hz, and so on. In this manner, the predominant frequency w and P harmonics may be found for a variety of configurations and baseline_RPMs of the UAS 10. Because the in-flight RPM is typically kept between 90% to 105% of the baseline RPM, dampening the frequency w and related P harmonics may substantially stabilize the camera system 16, resulting in improved image capture.

The camera mount 38 includes certain features that may dampen or otherwise minimize vibrations, such as the pistons 50 and springs 52, depicted in a top view of FIG. 3. In certain embodiments, the camera mount 38 may optimize the damping of the predominant frequency w and related P harmonics by tuning the pistons 50 and/or the springs 52 as described below. Additionally, the camera mount 38 includes features that enable the camera mount 38 to weigh, in some embodiments, less than 500 grams. By minimizing the weight of the camera mount 38, the UAS 10 may increase its operational range, speed, and/or hovering time.

In the presently contemplated embodiment illustrated in FIG. 3, the camera mount 38 includes four pistons 50, four springs 52, two axial arms 54, and four L-brackets 56 used to mount the four springs 52 to the airframe 44, as well as assorted mounting hardware (e.g., nuts, bolts, screws). In other embodiments, more or less of the components 50, 52, 54, and 56 may be used. However, minimizing the number of components 50, 52, 54, and 56 reduces weight while also increasing the reliability and maintainability of the camera mount 38. Indeed, by minimizing the component count, the camera mount 38 may be provided at a weight that maximizes the operational effectiveness of the UAS 10 while enabling the camera system 16 contained inside the gimbal system 12 to capture images substantially free of jitters and motion artifacts. Indeed, some embodiments may provide an isolation efficiency of over 80% and reduce vibrations of the camera system 16 to less than 0.025 in/sec., thus enabling sub-MOA accuracy for the weapon 24 as well as improved hovering, navigation and obstacle avoidance.

The arms 54 are mounted axially along the depicted y-axis of the airframe 44 and include a length l₂. In one embodiment, the length l₂ is at least 20% of the length l₁ of the UAS 10 shown in FIG. 1. In other embodiments, the length l₂ is between 10% to 50% of the length l₁. Indeed, the length l₂ is suitable for mounting a variety of gimbal systems 12 of different sizes, including the depicted gimbal system 12. The gimbal system 12 may be attached to the arms 54 by using mounting points 58. The mounting points 58 may include through holes or openings disposed on the arms 54 through which screws, bolts, or devices may be inserted (e.g., threaded) to side walls 60 of the gimbal system 12. That is, the walls 60 may be abutting the arms 54, and bolts may be inserted through the mounting points (e.g., holes) 58 in the arms 54 and threaded into the walls 60. Different sizes of gimbal systems 12 may be accommodated by moving gimbal systeming points 58. Moving the gimbal mounting points 58 outwardly closer to the pistons 50 allows for the installation of larger gimbal systems 12. Conversely, moving the mounting points 58 inwardly towards a center of the axial arms 54 allows for the installation of smaller gimbal systems 12. The mounting points 58 may be installed (e.g., pre-drilled) by the manufacturer to accommodate standard gimbal system 12 sizes, or may be installed on site to accommodate a custom gimbal system 12. Additional mounting points 58 may be disposed along the arms 54 to provide for a variety of gimbal system 12 sizes.

The arms 54 may be manufactured out of lightweight materials, including aluminum, titanium, carbon fiber, chro-moly, or a combination thereof. A variety of techniques may be used to manufacture the axial arms 54, such as computer numerical control (CNC) machining, milling, machine pressing, molding, overmolding, or a combination thereof. By providing for lightweight axial arms 54, the operational capabilities of the UAS 10, including speed, payload, hovering time, and range, may be improved.

The camera mount 38 provides for planar motion (e.g., motion about a geometric plane, such as the x-y plane) as well as for axial motion along an axis (e.g., z-axis) normal to that of the geometric plane having the planar motion. In the depicted embodiment, the planar motion is provided about the x-y plane, while the axial motion is provided along the z-axis, which is the axis normal to the x-y plane. The planar and axial motions enables the gimbal system 12 to “float” under the airframe 44, thus keeping the camera system 16 isolated, from vibrations that may be traveling through the airframe 44. Motion in the x-y plane may be provided by connecting the axial arms 54 to the airframe 55 through the pistons 50 rather than by using a rigid member (e.g., a rigid bar). It is be noted that motion in the x-y plane is not restricted to a subset of directions in the plane (e.g., only in the x-axis and only in the y-axis), but that the camera mount 38 may move in any direction on the x-y plane.

In one embodiment, rotatable couplings 62 are used to connect the pistons 50 to the arms 54 and to the bars 40 and 42. The rotatable couplings 62 may provide for 360° of rotation around a plane, such as the x-y plane. Accordingly, the pistons 50 are free to rotate in the x-y plane within bounds of the pistons' 50 geometric configuration. In other embodiments, the couplings 62 may be fixed and not rotate. In the depicted geometry, the pistons 50 connecting the arms 54 to the bar 40 are disposed at an angle α with respect to the arms 54, at an angle Q with respect to the bar 40. In certain embodiments, α and Q are approximately between 100° to 170°.

The pistons 50 connecting the arms 52 to the bar 42 are disposed at an angle β with respect to the arms 54 and at an angle F with respect to the bar 42. In certain embodiments, Q and F are approximately between 100° to 170°. In one embodiment, the angle β is smaller than α, and the angle Q is smaller than F. During flight, the angles α, β, Q and F may be constantly changing correlative to movements of the airframe 44. That is, the mass of the gimbal system 12 may tend to resist a change in its motion due to inertia, with the pistons 50 enabling the airframe 44 to move relative to the gimbal system 12, or vice versa.

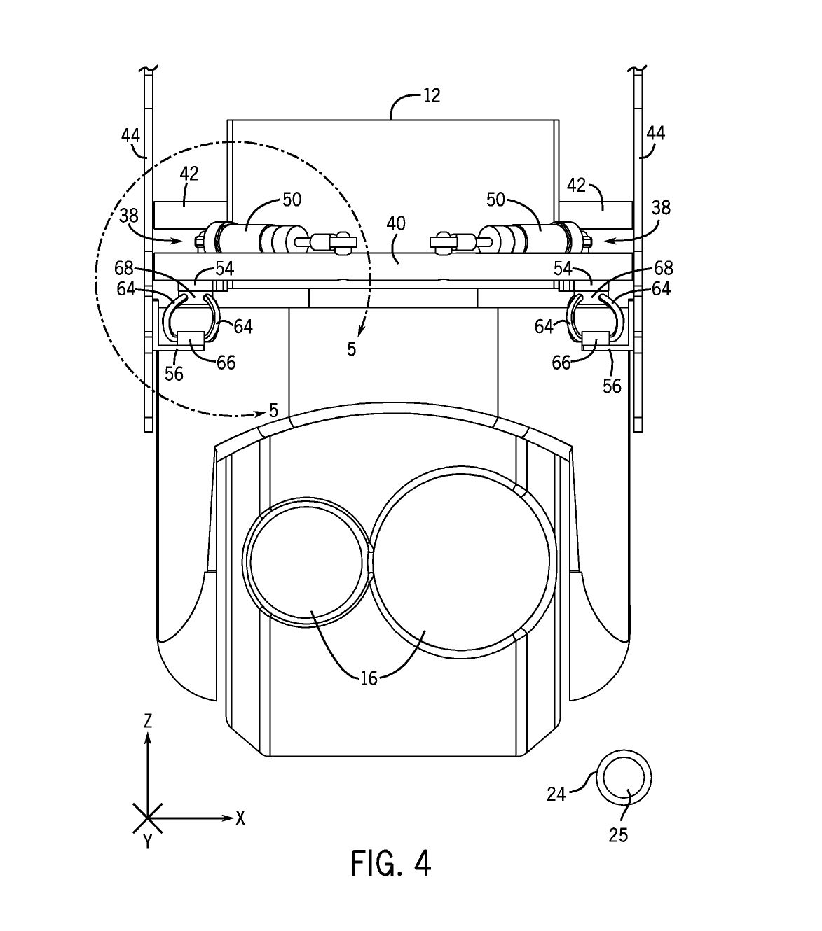

Additionally, the pistons 50 may be tuned to dampen certain of the predominant vibratory frequencies, including the frequency w and related P harmonics described above with respect to FIG. 1. For example, the pistons 50 may include oil, gasses, springs, and other mechanisms that are tunable to absorb mechanical oscillations occurring at the predominant vibratory frequency w and related P harmonics. Additionally, the pistons 50 may be adjusted for length of travel and response rate. By dampening the mechanical oscillations transmitted through the airframe 44, jitters and other unwanted movement may be minimized or eliminated. Indeed, oscillating kinetic energy caused by the predominant vibratory frequency w may be dissipated by the pistons 50, for example, as heat, resulting, in some cases, in an isolation efficiency of 80% and higher and a reduction to vibration levels of 0.025 in./sec. or lower. In this manner, the pistons 50 may dampen vibrations, while enabling movement of the gimbal system 12 in the x-y plane. Additionally or alternatively, the springs 52 may be used to dampen vibrations while enabling movement along the z axis, among other axes, as described in more detail below with respect to FIG. 4.

FIG. 4 is a front view illustrating the use of the springs 52 suitable for dampening vibrations as well as for providing movement of the gimbal system 12 and camera system 16 along the z-axis (and other axes). Indeed, by virtue of their flexible properties, the springs 52 may displace move along the z-axis, the x-axis, the z-axis, and other axes in-between these three aforementioned axes, providing for movement in any direction as well as dampening vibrations. For example, the springs 52 may dampen mechanical oscillations and a variety of unwanted motion, including vibrations created by the predominant vibratory frequency w and P harmonics.

In the depicted embodiment, the springs 52 include multiple flexible or elastic rods 64. In the presently contemplated example, the flexible rods 64 are manufactured out of wire rope (e.g., steel cable) consisting of several strands of metal wire twisted into a cable. In this embodiment, the flexible rods 64 are not coiled or helically wound like in a traditional metal spring coil, but rather secured to a bottom spring coupling 66 and top spring coupling 68, and then left to deflect or “bow” radially under a load, such as the mass of the depicted gimbal system 12 and camera system 16. It is to be noted that, in other embodiments, the rods 64 may include elastomer rods, plastic rods, and more generally, rods 64 capable of flexing or deflecting about an axis (e.g., z-axis). In yet other embodiments, traditional coiled springs may also be used. By using flexible rods 64 rather than traditional coiled springs, the camera mount 38 may provide for lighter weight spring embodiments having a more uniform motion in multiple directions.

The rod's 64 cross-sectional area, length, and material determine the amount of deflection or “bowing” d under the load. That is, the rods may be generally curved, as depicted, when experiencing the load. Column or beam deflection equations may be used to determine the amount of deflection d and the correlative spring force of the rods 64. For example, Hooke's law may be used to derive d under a compressive load, using equation (2):

$$δ = \frac{compressive\_load \times rod\_length}{E \times A} \qquad ( 2 )$$

E is Young's modulus (e.g., measure of stiffness of elasticity) of the rod's material and A is the cross-sectional area of the rod. The spring rate or force constant k for the rods 64 may then be derived by using equation (3):

$$k = \frac{E \times A}{rod\_length} \qquad ( 3 )$$

Accordingly, the rods 64 may be tuned to provide for a k suitable for dampening the predominant vibratory frequency w and related P harmonics. In one embodiment, dampened harmonic oscillator differential equations (4) and (5) may be used to derive k:

$$\begin{matrix}w = \sqrt{\frac{k}{compressive\_load}} ; and & ( 4 ) \\ \frac{{d}^{2} z}{d {t}^{2}} + 2 Sw \frac{d z}{d t} + {w}^{2} z = 0 & ( 5 )\end{matrix}$$

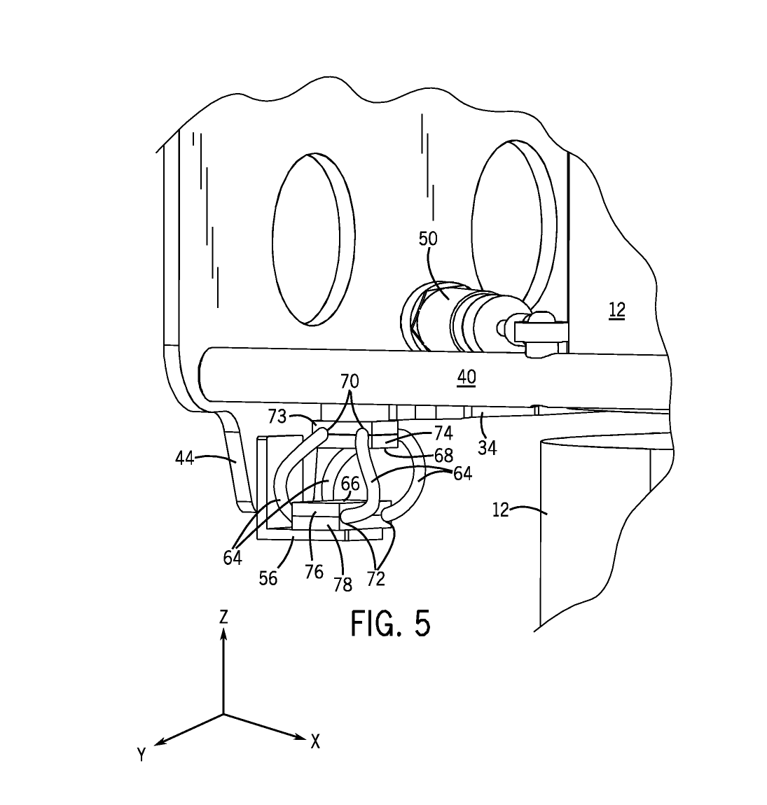

z is a displacement that dynamically oscillates along the axis of movement (e.g., z-axis), and t is time. By setting S=1, the load system (e.g., camera mount 38 and gimbal system 12) typically returns to equilibrium very quickly with minimal oscillation of z. Such equations may be solved for k manually or by using a mathematical package, such as the Mathematica software toolkit, available from Wolfram Research Co. of Champaign, Ill., USA. Once a desired k is derived, then other characteristics of the rods 64 may be determined (e.g., E, A, rod length) using the equation (3) above. Additionally or alternatively, empirical tests may be used to determine characteristics (e.g., E, A, rod length) of the rods 64 suitable for dampening the predominant vibration w of the UAS 10. For example, rods 64 of various lengths and diameters may be tested for their suitability to dampen w. In this manner, the rods 64 may be tuned to dampen unwanted vibration from the gimbal system 12, thus enabling the capture of high quality imagery through the camera system 16. The rods may be coupled to the axial arms 54 of the camera mount 38, as described in more detail with respect to FIG. 5 below.

FIG. 5 is a perspective view taken through arc 5-5 of FIG. 4 illustrating the use of the spring couplings 66 and 68 to attach the rods 64 to the axial arm 54 and to L-bracket 56. In the presently contemplated embodiment, 4 rods 64 are attached to each L-bracket 56. However, other embodiments may use more or less rods 54. In one example, the spring couplings 66 and 68 may include openings 70 and 72 through which the rods 64 may be inserted and secured to the spring coupling 66 and 68. For example, the spring coupling 66 may include two halves 72 and 74, while the spring coupling 68 may include two halves 76 and 78. Each of the two halves 72, 74, and 76, 78 may be clamped or otherwise secured to each other, thus securing the rods 64. In another example, the rods 64 may be welded or glued, or adhered to the spring couplings 66 and 68. The spring coupling 68 may then be attached to the axial arm, for example, by using a threaded bolt and a nut, welds, adhesives, and so on. Likewise, the spring coupling 66 may be attached to the L-bracket 56.

In the depicted embodiment, the openings 70 are positioned facing the y-axis while the openings 72 are positioned facing the y-axis. Accordingly, an upper end of the rods entering the openings 70 is twisted at an angle of 90° compared to a lower end of the rods entering the openings 22. Such a 90° twist in the rods 64 may increase the spring rate k and provide for added stiffness, thus increasing the amount of load that may be carried on the rods while minimizing the deflection d. In other embodiments, the rods 64 may be twisted at between 10° to 90°, 90° to 180°, 180° to 360°, or greater than 360°. In yet another embodiment, the openings 70 and 72 may share the same axial orientation, resulting in rods 64 having no twist.

As the load (e.g., gimbal system 12 and camera system 16) on the axial arms 54 moves, the rods 64 may extend or compress to accommodate the movement. Because the rods 64 are oriented to deflect mostly along the z-axis, the rods 64 may provide for easier movement and dampening of vibrations along the z-axis. However, because of the elastic properties of the rods 64, movement in any direction may be accommodated. For example, the axial arms 54 may move along the x-axis, the y-axis, or in any other direction and the rods 64 will elastically comply or deform with the movement. Additionally, the rods 64 will provide for a resistive force against the movement, thus aiding in dampening unwanted motions. By providing for the rods 64 as dampening components additional or alternative to the pistons 50, the camera mount 38 may substantially reduce or eliminate unwanted motion, thus enabling the camera system 16 to capture high quality imagery. Indeed, the UAS 10 may be controlled to hover within ±0.5 in. or better, of a desired hovering position, suitable for targeting at precisions of 1 MOA or better. Likewise, the vibration may be reduced to 0.025 in/sec. or less, which may result in an isolation efficiency of over 80%.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

What is claimed is:

1. A camera mount system comprising:
a first and a second axial arm configured to mount a camera system;
a plurality of pistons configured to attach the first and the second axial arms to a vehicle frame; and
a plurality of springs configured to attach the first and the second axial arms to the vehicle frame, wherein the first and the second axial arms are disposed underslung to the vehicle frame, and wherein the pistons enable a first movement of the first and the second axial arms about a geometric plane and the springs enable a second movement of the first and the second axial arms along an axis normal to the geometric plane.

2. The system of claim 1, wherein at least one of the springs comprises a first flexible rod configured to deflect about the axis normal to the geometric plane.

3. The system of claim 2, wherein the first flexible rod comprises a wire cable, a plastic, an elastomer, or a combination thereof.

4. The system of claim 2, wherein the at least one of the springs comprises a second flexible rod configured to deflect about the axis normal to the geometric plane.

5. The system of claim 2, comprising a first spring coupling having a first surface configured to attach a first end of the first flexible rod to the first axial arm, and a second spring coupling having a second surface configured to attach a second end of the flexible rod to the vehicle frame, and wherein the first surface is at an angle of 90° relative to the second surface.

6. The system of claim 1, wherein the plurality of pistons comprise a first piston configured to attach to the first axial arm at an angle α of approximately between 100° to 170° and to a first bar of the vehicle frame at an angle Q of approximately between 100° to 170°.

7. The system of claim 6, wherein the plurality of pistons comprise a second piston configured to attach to the first axial arm at an angle β of approximately between 100° to 170° and to a second bar of the vehicle frame at an angle F of approximately between 100° to 170°, and wherein β<α, and Q<F.

8. The system of claim 1, wherein at least one of the pistons, at least one of the springs, or a combination thereof, is configured to dampen a predominant vibration of the vehicle frame caused by a rotation of a blade.

9. The system of claim 1, wherein the wherein the plurality of pistons, the plurality of springs, or a combination thereof, are configured to reduce a vibration to provide a targeting accuracy of 1 minute of angle (MOA) or better.

10. The system of claim 1, wherein the plurality of pistons, the plurality of springs, or a combination thereof, are configured to provide a vibration isolation efficiency of 80% or more.

11. The system of claim 1, wherein the plurality of pistons, the plurality of springs, or a combination thereof, are configured to reduce a vibration of the camera system to less than 0.025 inches per second.

12. The system of claim 1, wherein the vehicle frame is included in at least one of a fixed wing aircraft or in a rotary wing aircraft.

13. An unmanned aircraft system (UAS) comprising:
an airframe having a first length; and
a camera mount system comprising:
a first and a second axial arm having a second length at least 20% of the first length and configured to carry a camera system;
a plurality of pistons attached to the first and the second axial arms and to the airframe; and
a plurality of springs attached to the first and the second axial arms and to the airframe, wherein the pistons enable a first movement of the first and the second axial arms about a geometric plane and the springs enable a second movement of the first and the second axial arms along a first axis normal to the geometric plane.

14. The system of claim 13, wherein at least one of the plurality of springs comprises a flexible rod configured to deflect under a load.

15. The system of claim 14, wherein the flexible rod comprises a twist of 90° about the first axis.

16. The system of claim 13, wherein the springs enable a third movement of the first and the second axial arms in any direction.

17. The system of claim 13, wherein the first length is less than 15 ft.

18. The system of claim 13, wherein the plurality of pistons, the plurality of springs, or a combination thereof, are configured to reduce vibration of the camera system to enable hovering of the UAS to within 1 inch or less from a desired hovering position.

19. An unmanned aircraft system (UAS) comprising:
an airframe;
a rotary blade mechanically coupled to the airframe; and
a camera mount system comprising:
a first and a second axial arm configured to mount a camera system;
a plurality of pistons configured to attach the first and the second axial arms to the airframe; and
a plurality of springs configured to attach the first and the second axial arms to the airframe, wherein the pistons enable a first movement of the first and the second axial arms about a geometric plane and the springs enable a second movement of the first and the second axial arms along an axis normal to the geometric plane, and wherein at least one of the pistons or at least one of the springs is configured to dampen a first vibration substantially produced by the rotary blade.

20. The system of claim 19, comprising a main rotor, wherein the rotary blade is included in the main rotor.

21. The system of claim 19, comprising a tail rotor, wherein the rotary blade is included in the tail rotor.

22. The system of claim 19, wherein the plurality of pistons, the plurality of springs, or a combination thereof, are configured to reduce a vibration of the camera system to enable obstacle avoidance when flying at speeds in excess of 50 miles per hour.
